(19) United States
(12) Patent Application Publication
(10) Pub. No.: US 2006/0263897 A1
(43) Pub. Date: Nov. 23, 2006

(54) Nanoparticles for detecting analytes

(75) Inventors: Hendrik Roelof Stapert, Eindhoven (NL); Rifat Ata Mustafa Hikmet, Eindhoven (NL); Joukje Garrelina Orsel, Valkenswaard (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/570,444

(22) PCT Filed: Sep. 7, 2004
(86) PCT No.: PCT/IB04/51698

§ 371 Date: Mar. 2, 2006

(30) Foreign Application Priority Data
Sep. 9, 2003 (EP) 03103321.0

(51) Int. Cl. G01N 31/22

(52) U.S. Cl. 436/166; 977/774

(57) ABSTRACT

The invention relates to a device for detecting an analyte comprising a group that can form a covalent bond with the analyte and a detectable moiety, characterized in that the device is a nanoparticle and the detectable moiety is magneto-active, electro-active, or optically active, and to a method for detecting an analyte using a nanoparticle comprising a magneto-active, electro-active or optically active group and a group that can form a covalent bond with the analyte, comprising the steps: a) protecting groups that can form a covalent bond with the nanoparticle, if present on the capture probe; b) bonding the analyte to the optionally protected capture probe to obtain an analyte-capture probe complex of which the analyte contains at least one group that can form a covalent bond with the nanoparticle; c) bringing into contact the analyte-capture probe complex and the nanoparticle to form a covalent bond with each other, d) detecting the analyte which is covalently bonded to the nanoparticle by an amperometric, impedimetric, magnetic, or optical method.

The invention relates to a device for detecting an analyte comprising a group that can form a covalent bond with the analyte and a detectable moiety. The invention further relates to a method for detecting the analyte using said device, to a kit of parts containing the same, and to a calibration method using said device.

Methods for detecting analytes are known in the art. Nucleic acid ligand biochips have been described by Gold et al. in U.S. Pat. No. 6,242,246 and U.S. Pat. No. 6,458,543. These biochips consist of a solid support on which one or more nucleic acid ligands are attached in a spatially defined manner. Each nucleic acid ligand can form a specific and avid bond to a particular target molecule contained within a test mixture, such as a bodily fluid. The target molecule can be a protein, hormone, drug, cell, chemical, and the like.

Nucleic acids that can bond molecules other than their complementary sequence are often called aptamers. An aptamer typically contains 30-80 nucleic acids and can have a high affinity towards a certain target molecule (K_{d}'s reported are between 10⁻¹¹-10⁻⁶ mole/l). The aptamers are selected for their affinity in a so-called SELEX or PHOTOSELEX process, which was described in U.S. Pat. No. 6,482,594, U.S. Pat. No. 6,291,184, U.S. Pat. No. 6,376,190 and U.S. Pat. No. 6,458,539.

For a typical photo-aptamer array for protein detection, the following steps are usually performed: 1) incubating aptamer array and test mixture; 2) washing away test mixture (pre cross-link wash); 3) cross-linking aptamer and bonded target using 308 nm light; 4) post cross-link washing; 5) incubating array in staining solution; 6) removing staining solution; 7) detecting stain; 8) analyzing data.

For detecting analytes nanoparticles have also been disclosed. In U.S. Pat. No. 6,548,311 a method is described for detecting analytes, as well as a device for carrying out the method, for use for analysis or diagnosis in the fields of chemistry, biochemistry, molecular genetics, food chemistry, biotechnology, the environment, and medicine. Marker particles with different electrical properties or a different relative permeability to those of the measuring solution surrounding them are used to detect the analytes. The marker particles either bond specifically to the analytes or to a binding site in competition with the analyte. The analytes are detected by changes in an electrical field or an electrical current generated by electrodes, or in an electrical voltage applied to an electrode or in a magnetic field, said changes being caused by marker particles, which have bonded with the analytes or by marker particles, which have instead bonded to the binding site in an electrical field. These marker particles may be nanoparticles, but they always bond to the analyte through an antibody that is contained on the marker particle. The disadvantage of such method is that each type of analyte needs another antibody. Thus, in practice various nanoparticle-antibody complexes need to be made to bond with various analytes. It would be a considerable advantage to have nanoparticles that are not specific in this respect and can be used for any analyte, without modifying the surface of the nanoparticles.

The staining of proteins (the hereinabove mentioned step 5) when using a (photo)-aptamer array is usually performed with a fluorophore that bonds chemically to the free amine groups present on the aptamer-bonded target molecule. The bonding to amine functionality is especially suitable because practically no reaction will occur with (unbonded) aptamers. A problem using fluorescence is the background signal that occurs due to auto-fluorescence of the array substrate.

Other detection methods for target bonding that do not require fluorescence are known from U.S. Pat. No. 6,242,246 and U.S. Pat. No. 6,458,543, which specifically mention a) chemical field effect transistor that exploits the local change in chemical potential at the insulative gate; b) surface plasmon resonance that uses the change in the refractive index at a metallic surface; c) mass spectrometry, detecting the time of flight (mass) of the ionization products after irradiation with a laser capable of ionizing molecules on the chip surface, and d) atomic force microscopy and scanning tunneling microscopy, that detect the topology of the surface at the nanometer level.

The above proposed detection techniques are either not sensitive enough for detection of low amounts of bonded proteins or can not easily be miniaturized for application in cartridges for molecular diagnostics. Moreover, the hereinabove described techniques require separate calibration for every different protein.

Another disadvantage of the known methods is the occurrence of cross-reactivity of the different biomolecules, leading to false positive results in the detection. In case of use of a plurality of analytes on the same surface (i.e. an array) the use of labeled biomolecules in the development step is strongly complicated by non-specific cross-reactivity of biomolecules.

It is therefore an objective of the present invention to provide nanoparticles for non-specific binding of analytes, allowing for their detection with high sensitivity. Such nanoparticles have the additional advantage of providing a universal calibration method making separate calibration for different target molecules redundant. These and other aspects of the invention will be apparent from and elucidated with reference to the embodiments described hereinafter.

Thus more particularly, the invention pertains to nucleic acid, polysaccharide, lipid, (modified) antibodies, (modified) protein, peptide, or hormone ligand biochips comprising a solid support on which the ligands are attached. These ligands bond specifically to particular target molecules (e.g. proteins, hormones, cells, drugs, and the like) within a test mixture.

To this end, the invention relates to a device for detecting an analyte comprising a detectable moiety and a group that can form a covalent bond with the analyte, characterized in that the device is a nanoparticle and the detectable moiety is magneto-active, electro-active, or optically active.

According to the invention, the detection of the target molecules involves particles having a size in the nm-μm range, more specifically having a diameter in the range from 1 nm to 5 μm, and that are covalently bonded to, for instance, amino acids of the analytes. In particular there may be employed paramagnetic particles, super-paramagnetic particles, metallic particles, ferro-electric particles, electrically charged particles, E-beads, or fluorescent quantum dots. These particles (or beads) influence the surface (di)electric or magnetic properties giving rise to a change in surface properties, which can be detected by amperometric, impedimetric, magnetic, or optical methods.

This invention further relates to sensitive detection methods for target molecules using ligand arrays, such as nucleic acid ligand arrays. Furthermore, it is the objective of this invention to provide a universal calibration method that will directly relate the measured signal to the amount of surface bonded target molecules. The surface bonded target molecule concentration can then be related to the unknown concentration of the test solution, for example using the equilibrium affinity constant (Kₐ or K_{d}) of the aptamer or any other ligand, for a certain target and a surface bonding model (such as the Langmuir adsorption isotherm) that describes ligand-analyte adsorption on surfaces.

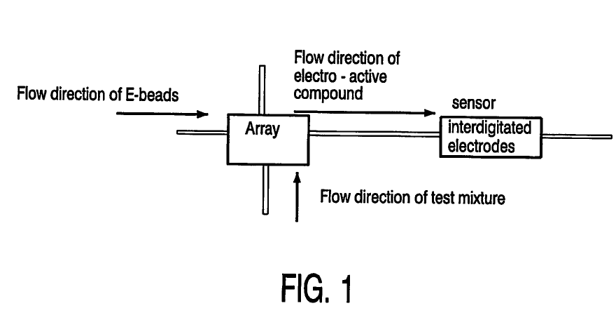

E-beads are particles that release electro-active molecules upon a stimulus (heat, light, chemical reaction, and the like). Bonding of surface modified E-beads (e.g. carboxylated, aminolated, biotinylated, and the like) to the ligand-bonded protein (or other analyte) can be performed as is generally known in the art. Of particular interest is the coupling of E-beads via activated esters at a suitable pH, such as about 8.5, targeting the primary amines of the protein. When the E-beads have reacted and unreacted beads have been removed, the stimulus can be applied and electro-active molecules are released into the solution. These molecules are preferably detected downstream, on an electrode, preferably an interdigitated electrode with small spacing (preferably less than 100 micron, more preferably less than 20 micron, most preferably less than 2 micron) at a potential at which the electro-active species are oxidized and/or reduced resulting in a Faradaic current. To obtain a stable reading, the electro-active species preferably is a redox recycling compound, such as p-aminophenol or quinone. The interdigitated electrodes are preferably located such that contact with the test mixture is avoided thereby preventing fouling of the electrodes. This is further shown in FIG. 1, which shows an example of an amperometric sensor design for ligand array and E-bead stains.

Generally, preferred bonding is obtained for analytes wherein the group that can form a covalent bond with the analyte comprises at least a carboxylate, an activated ester, an acyl halide, an amine, a sulfurhydryl, an epoxy, or a hydroxy group. Activated esters are known to the person of ordinary skill and include for instance a succinimide ester.

An advantage of the present invention is the easy detection of any analyte using the same nanoparticle. Thus the invention also relates to a method for detecting an analyte using a nanoparticle comprising a magneto-active, electro-active, or optically active group and a group that can form a covalent bond with the analyte, comprising the steps:
a) protecting groups that can form a covalent bond with the nanoparticle, if present on a capture probe;
b) bonding the analyte to the optionally protected capture probe to obtain an analyte-capture probe complex of which the analyte contains at least one group that can form a covalent bond with the nanoparticle;
c) bringing into contact the analyte-capture probe complex and the nanoparticle to form a covalent bond with each other; and
d) detecting the analyte which is covalently bonded to the nanoparticle by an amperometric, impedimetric, magnetic, or optical method.

The group that can form a covalent bond with the analyte is usually another group than the magneto-active, electro-active, or optically active group, but it may be the same group, or a part thereof.

Preferably, the capture probe is an aptamer, a peptide, a protein, an antibody, a carbohydrate, a lectin, a hormone, or a lipid. More preferably, the capture probe is attached to a solid support.

Amperometric detection can also be achieved when the capture probe bonded analyte is stained with an enzyme, for example horseradish peroxidase or alkaline phosphatase. After staining a substrate is added, which is transformed to a redox-active compound by the enzyme. The redox-active compound preferably is a redox-recycling compound.

When the staining of the capture probe-bonded analyte is performed with a particle that has a large influence on the surface dielectric properties, i.e. the surface charge density, a change in the surface impedance can be measured (impedimetric detection). This change can be caused by a change of the double layer capacitance and/or of the surface potential, through the bonding of particles with a high charge density, such as gold colloids or high polarizability, such as ferro-electric particles.

Staining of a capture probe-bonded analyte can be performed with surface modified super paramagnetic particles. Detection of reacted particles can be performed either by GMR (Giant Magnetic Resonance) detection or by inductive methods. Suitable diameter sizes of super-paramagnetic particles are 5 nm to 3 μm, more preferably between 10 and 350 nm.

The surface of the particles should be modified such that cross-linking with the protein can be achieved. Of particular interest is the coupling via activated esters at about pH 8.5 targeting the primary amines of the protein.

Unbonded magnetic particles can be removed from the surface by applying a magnetic field such that the field gradient is away from the surface. This makes the necessity of a washing step redundant. For small magnetic particles (<1 micron, i.e. low magnetization) a very high field may be necessary. In this case the unreacted particles can be removed by adding larger particles that have a higher magnetization and thus can be used at lower external fields. Due to the relatively close vicinity of the larger particle, smaller particles become attracted and can thus be removed from a surface.

Fluorescent detection using functional quantum dots can also be applied. Quantum dots are small semi-conducting particles with very bright emission properties. The emission wavelength depends on the size of the quantum dots. Staining of capture probe-bonded analytes can be performed with surface modified quantum dots. For example, a CdSe/ZnS core shell particle can be modified with mercapto alkylcarboxylic acid groups, thus giving carboxylic acid functionality to the outer surface of the quantum dot. This functionality can be used for coupling to primary amine groups of the analyte.

The invention also pertains to a universal calibration method using nanosized particles instead of molecularly dissolved molecules (“dyes”) as a stain for e.g. aptamer bonded proteins, which gives a strong advantage in terms of calibration. For molecularly dissolved dyes, a protein bonded to an aptamer will be stained with more than one dye molecule. The number of bonded dye molecules will depend on the size of the protein, the efficiency of the staining reaction and the number of reactive groups on the protein. This means that the (fluorescent) signal for a certain surface concentration is different for every protein. Moreover, intramolecular quenching effects will add to the analyte (e.g. protein) dependent (fluorescent) signal. It would be highly desirable if the measured signal upon staining is the same for every aptamer-bonded protein and is only a function of surface concentration (coverage). This is possible when only one nanosized particle bonds to one protein. Therefore, universal (surface) calibration can be obtained by performing the staining reaction with particles of suitable size in such a way that only one particle will bond to one analyte. The size of the particle should be such that upon bonding it will hinder other particles to bond to the said analyte, but will not hinder bonding to other bonded analyte molecules on the surface. Preferred diameter sizes of the particles are between 1 and 100 nm, preferably between 3 and 25 nm. Examples of particles are luminescent quantum dots, ferro-electric particles, super-paramagnetic particles, E-beads, and gold colloids.

The surface bonded target molecules can then be related to the unknown concentration using for example the equilibrium affinity constant (Kₐ or K_{d}) of the aptamer for a certain target and a surface bonding model (such as the Langmuir adsorption isotherm) which describes protein adsorption on aptamer modified surfaces.

The same method of calibration can be applied to immuno-sandwich assays. Specific linking chemistry to allow for only one particle to bond to secondary antibodies can for example be achieved via the sugar groups of the antibody, using common methods of sugar linking chemistry.

Finally, the nanoparticles can be sold as a part of an assay for detecting an analyte Said nanoparticles, for instance can be combined with the biochip or other materials for detection. The invention therefore also pertains to a kit of parts comprising:
a) magneto-active, electro-active, or optically active nanoparticles comprising a group that can form a covalent bond with an analyte;
b) a capture probe that is not reactive to the nanoparticle, which optionally may be immobilized onto a solid support; and
c) optionally a solid support for immobilizing the capture probe.

The invention is illustrated by the following non-limitative examples.

### EXAMPLES

According to preferred embodiments of the invention, the luminescent inorganic particles are CdS, CdTe, CdSe, ZnS, ZnSe, PbS, HgS, HgTe, GaAs, GaP, InAs, InP, and ZnO, which are round, disc like, or rod like in shape. In order to functionalize the surface of such particles groups such as thiol, carboxylic acid, amine, or phosphine groups can be used.

Colloidal luminescent CdSe/ZnS core-shell nanocrystals were synthesized via a two-stage approach described in D. V. Talapin, A. L. Rogach, A. Kornowski, M. Haase, and H. Weller, Nano Lett., 1, 207 (2001)). Briefly, at the first stage the monodisperse CdSe nanocrystals were prepared by reacting dimethyl cadmium with trioctyl phosphine selenide in the hexadecyl amine-trioctyl phosphine oxide-trioctyl phosphine (HDA-TOPO-TOP) stabilizing mixture at 270-310° C. The ZnS shell around the colloidal CdSe cores was grown by slow addition of dimethyl zinc and bis-trimethyl silylsulfide (zinc and sulfur precursors, respectively) to the solution of CdSe cores in the HDA-TOPO-TOP mixture at 180-220° C. This mixture was purified by precipitation, dried, and redissolved in non-polar solution to give the quantum dot (QD) solution. The resulting CdSe/ZnS core-shell nanocrystals were soluble in non-polar solvents like chloroform or toluene.

The surface of the particles was modified using e.g. mercaptopropionic acid or acetyl cysteine. In order to modify the surface of the quantum dots (QD's) they were subjected to standard capping exchange procedure. An excess amount of thiol-containing molecules was added to the QD solution in chloroform and stirred at 50° C. for several hours. Modified QD tend to precipitate slowly upon cooling or by addition of methanol. The dissolution and precipitation steps were repeated several times in order to remove thiol-containing molecules, which were not bound to QD surfaces. The resulting QDs show reasonable to good solubility in aqueous solutions. The carboxylic groups on the surface of the QDs have been activated using EDC (1-(3-dimethylaminopropyl)-3-ethylcarbodiimide) and NHS (N-hydroxy-succinimide) activation.

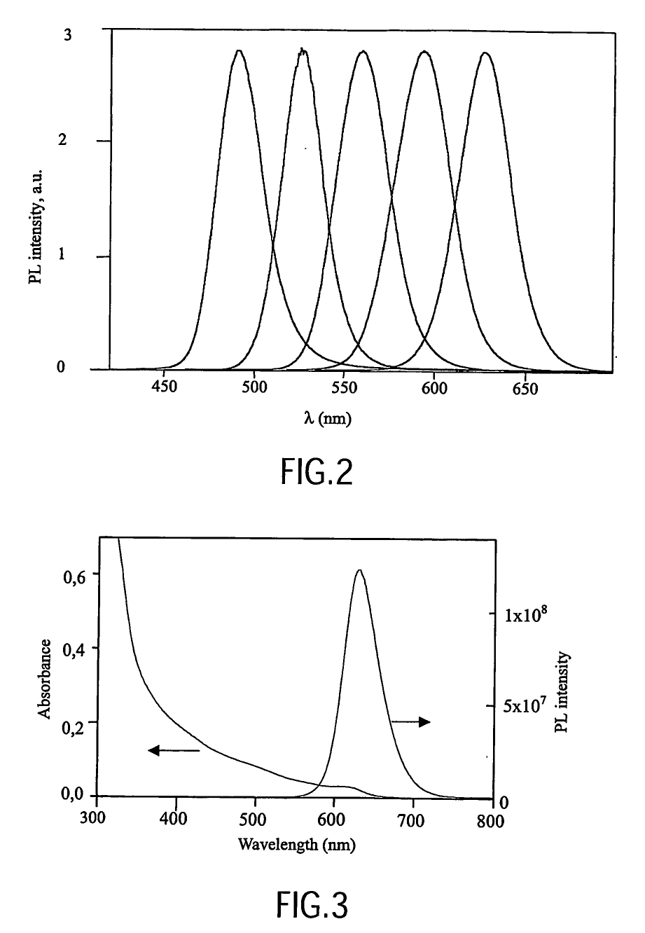

Core-shell CdSe/ZnS nanocrystals exhibit strong band-edge photoluminescence with room temperature quantum efficiencies as high as 30-70%. The spectral position of the emission band is tuneable from blue to red by increasing the size of CdSe core from about 2 to 6 nm. (FIG. 2). A thin (about 2 monolayers) ZnS epitaxial shell grown around a CdSe core considerably improves particle stability and the luminescence efficiency.

In FIG. 2 the emission spectra of quantum dots with a core-shell (CdSe core ZnS shell) structure are shown. The emission spectra with sharp peaks were obtained using quantum dots of various sizes with a narrow size distribution. It can be seen that by changing the size of the quantum dots also the emission wavelength changes.

In FIG. 3 emission from CdSe/ZnS/propionicacid quantum dots with a CdSe core of about 6 nm covalently bonded via an amide link to a protein bonded to a solid support is shown together with its absorption spectrum.

In the claims:

1. A device for detecting an analyte comprising a detectable moiety and a group that can form a covalent bond with the analyte, characterized in that the device is a nanoparticle and the detectable moiety is magneto-active, electro-active, or optically active.

2. The device of claim 1 wherein the nanoparticle has a diameter in the range from 1 nm to 5 μm.

3. The device of claim 1 wherein the group that can form a covalent bond with the analyte comprises at least a carboxylate, an activated ester, an acyl halide, an amine, a sulfurhydryl, an epoxy, or a hydroxy group.

4. The device of claim 1 wherein the nanoparticle is selected from a paramagnetic particle, a super-paramagnetic particle, a metallic particle, a ferro-electric particle, an electrically charged particle, an E-bead, or a fluorescent quantum dot.

5. A method for detecting an analyte using a nanoparticle comprising at least a magneto-active, electro-active, or optically active group and a group that can form a covalent bond with the analyte, comprising the steps:
a) protecting groups that can form a covalent bond with the nanoparticle, if present on a capture probe;
b) bonding the analyte to the optionally protected capture probe to obtain an analyte-capture probe complex of which the analyte contains at least one group that can form a covalent bond with the nanoparticle;
c) bringing into contact the analyte-capture probe complex and the nanoparticle to form a covalent bond with each other; and
d) detecting the analyte which is covalently bonded to the nanoparticle by an amperometric, impedimetric, magnetic, or optical method.

6. The method according to claim 5 wherein the capture probe is selected from an aptamer, a peptide, a protein, an antibody, a carbohydrate, a lectin, a hormone, and a lipid.

7. The method according to claim 5 wherein the capture probe is attached to a solid support.

8. A kit of parts comprising:
a) magneto-active, electro-active, or optically active nanoparticles comprising a group that can form a covalent bond with an analyte;
b) a capture probe that is not reactive to the nanoparticle, which optionally may be immobilized onto a solid support; and
c) optionally a solid support for immobilizing the capture probe.
A universal calibration method for staining a capture probe that directly relates the measured signal to the amount of a thereto bonded analyte, using the nanoparticles of claim 1, by performing the staining reaction with the nanoparticles in such a way that only one nanoparticle bonds to one analyte.
